(19) United States
(12) Patent Application Publication
(10) Pub. No.: US 2005/0119910 A1
(43) Pub. Date: Jun. 2, 2005

(54) Content update notification

(75) Inventor: Haim Schneider, Ramot Meir (IL)

Correspondence Address: HOFFMAN, WARNICK & D'ALESSANDRO LLC, THREE E-COMM SQUARE, ALBANY, NY, 12207, US

(73) Assignee: International Business Machines Corporation, Armonk, NY (US)

(21) Appl. No.: 10/997,828

(22) Filed: Nov. 24, 2004

Related U.S. Application Data
(63) Continuation-in-part of application No. 10/724,931, filed on Dec. 1, 2003.

(51) Int. Cl. G06F 17/60

(52) U.S. Cl. 705/1; 705/26

(57) ABSTRACT

A content update notification system including a content update sub-system including a session manager operative to associate a web page currently active at a client, a subscription manager operative to create the subscription on a publish/subscribe server, an event buffer operative to store a content update notification received from the publish/subscribe server in response to the content update notification being received from a content provider and in connection with the subscription, and a monitor operative to receive the content update notification from the content update sub-system and provide an indication in association with the web page that a content update is available for the web page.

### CROSS-REFERENCE TO RELATED APPLICATIONS

This application is a continuation-in-part of U.S. patent application Ser. No. 10/724931, filed Dec. 1, 2003, entitled “Subscription-based dynamic content update,” and incorporated herein by reference in its entirety.

### FIELD OF THE INVENTION

The present invention relates to client-server technology in general, and in particular to subscription-based dynamic content updates, such as of web portals.

### BACKGROUND OF THE INVENTION

The Internet-based World Wide Web has evolved from a distributed file system in which users could request delivery of already-generated static documents, to a system in which dynamic and personalized content is generated in real time and served to users. One area of increasing popularity where this trend is evident is in content frameworks such as those commonly referred to as “portals.” A portal is typically designed to serve as a gateway, or focal point, through which users access information and applications from many different sources. A portal web page typically includes multiple “portlets” which are specialized content areas that occupy small defined windows within the portal page. For example, one portlet might contain a travel itinerary, while another portlet contains sports scores. The content, appearance, and position of a portlet may be personalized for each particular user.

While a portal page and the portlets it contains may be dynamically generated in response to a user accessing the portal, once the user receives the portal page the information it contains is not typically updated automatically. Thus, for example, a user who views a portal page and wishes to know after several minutes if the sports scores he is viewing have changed, must manually reload the portal page in order to get the updated information.

While some portals automatically refresh the portal page periodically, this approach has several drawbacks. These include putting a heavy load on the portal server which must repeatedly perform data retrieval and rendering for each portlet, and disrupting the user's viewing experience as the whole portal page keeps refreshing while the user is watching it, even if no content has changed.

An improved approach for updating web page content, and particularly user-customized portlet content, would therefore be advantageous.

### SUMMARY OF THE INVENTION

The present invention provides an improved approach for updating web page content, such as portlet content, whereby a publish/subscribe mechanism is used to identify content updates and provide notifications of such updates to a server. A web-page based monitor at the client periodically polls or otherwise monitors the server for content update notifications and provides an indication to the user who has retrieved the web page that a content update is available. Thus, the user need only reload the web page after such a notification is received.

In one aspect of the present invention a content update notification system is provided including a content update sub-system including a session manager operative to associate a web page currently active at a client, a subscription manager operative to create the subscription on a publish/subscribe server, an event buffer operative to store a content update notification received from the publish/subscribe server in response to the content update notification being received from a content provider and in connection with the subscription, and a monitor operative to receive the content update notification from the content update sub-system and provide an indication in association with the web page that a content update is available for the web page.

In another aspect of the present invention the system further includes a server operative to host a web site including at least one software component for dynamically generating at least one specialized content area of the web page, and provide the web page for display on a client computer.

In another aspect of the present invention the server is a portal server and where the web site is a portal.

In another aspect of the present invention the software component is a portlet.

In another aspect of the present invention the monitor maintains a persistent connection with the content update sub-system through which the monitor receives the content update notification.

In another aspect of the present invention the monitor periodically polls the content update sub-system for the existence of the content update notification.

In another aspect of the present invention a method is provided for providing a notification of updated content, the method including associating a web page currently active at a client with a subscription for content therefor, receiving a content update notification from a content provider in connection with the subscription, and providing an indication in association with the web page that a content update is available for the web page.

In another aspect of the present invention the method further includes creating the subscription on a publish/subscribe server, and storing the content update received from the publish/subscribe server in response to a publication received from the content provider and in connection with the subscription.

In another aspect of the present invention the method further includes dynamically generating the web page including at least one specialized content area, and providing the web page and the monitor to a client computer.

In another aspect of the present invention a computer program is provided embodied on a computer-readable medium, the computer program including a first code segment operative to associate a web page currently active at a client, a second code segment operative to receive a content update from a content provider in connection with the subscription, and a third code segment operative to provide an indication in association with the web page that a content update is available for the web page.

In another aspect of the present invention the computer program further includes a fourth code segment operative to create the subscription on a publish/subscribe server, and a fifth code segment operative to store the content update received from the publish/subscribe server in response to a publication received from the content provider and in connection with the subscription.

### BRIEF DESCRIPTION OF THE DRAWINGS

The present invention will be understood and appreciated more fully from the following detailed description taken in conjunction with the appended drawings in which:

FIG. 1 is a simplified block-flow diagram of a subscription-based dynamic content update system, constructed and operative in accordance with a preferred embodiment of the present invention;

FIG. 2 is a simplified flowchart illustration of an exemplary method of operation of the subscription-based dynamic content update system of FIG. 1;

FIG. 3 is a simplified flowchart illustration of an exemplary method of operation of the subscription-based dynamic content update system of FIG. 1, operative in accordance with a preferred embodiment of the present invention; and

FIG. 4 is a simplified illustration of a portal page of the present invention.

### DETAILED DESCRIPTION OF PREFERRED EMBODIMENTS

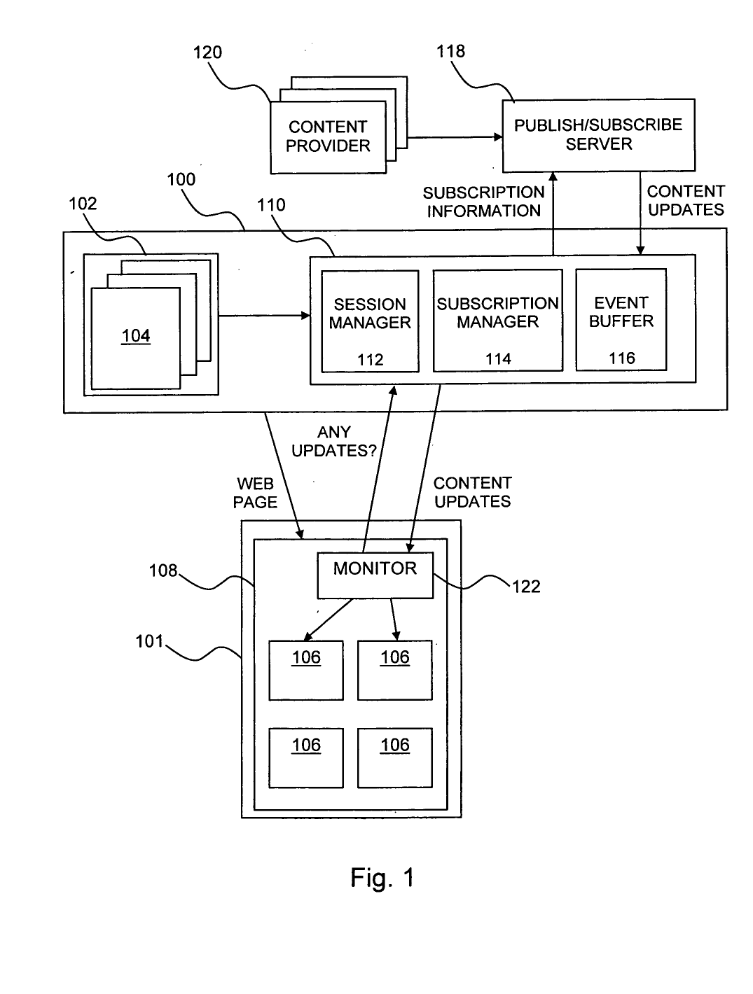

Reference is now made to FIG. 1, which is a simplified block-flow diagram of a subscription-based dynamic content update system, constructed and operative in accordance with a preferred embodiment of the present invention. In the system of FIG. 1 a server 100, such as a portal server, hosts a web site 102, such as a portal. Web site 102 includes one or more software components 104, such as portlets, for dynamically generating specialized content areas 106 of a web page 108 that is provided to a client computer 101, such as for display. Software components 104 also preferably generate subscriptions for content for one or more of specialized content areas 106. Server 100 also includes a content update sub-system 110 which preferably includes a session manager 112, a subscription manager 114, and an event buffer 116. Session manager 112 associates an instance of a web page currently displayed or otherwise active on a client with the set of subscriptions for content generated therefor. Subscription manager 114 creates and removes subscriptions for content on a publish/subscribe server 118, such as an IBM MQ Series or any other message-oriented middleware system that provides publish/subscribe services. Event buffer 116 stores content updates that are received from publish/subscribe server 118 in response to publications received from one or more content providers 120 and in connection with subscriptions. Web page 108 preferably includes a monitor 122 that periodically polls sub-system 110 for the existence of content updates with respect to specialized content areas 106, and provides the content updates to specialized content areas 106. Alternatively, monitor 122 maintains a persistent connection with sub-system 110 through which monitor 122 receives content updates as they arrive from the publish/subscribe server.

The subscription is preferably defined such that it identifies any change to the source of the content that is displayed by the user-customized portlet and that would cause the portlet to display different content if it were refreshed. For example, a user who is interested in financial news relating to IBM may access a portal web page that includes a user-customized portlet that displays such news. A subscription for financial news relating to IBM would then be established for the user-customized portlet. When a new news item that matches the subscription criteria is published it is sent to the user as a content update and the portlet is refreshed, causing the updated content to be displayed.

A content update may be represented in a text format that the portlet can parse, and from which the portlet can extract information for refreshing the content. For example, the content update may be in Extensible Markup Language (XML) format that may include hypertext links, such as to a new news item. Specifically, the Rich Site Summary (RSS) format of XML may be used for representing news headlines, including a news header, a publication time, and a link to the news item. The portlet may be configured to parse the RSS message using conventional techniques, extract information for display, and use Dynamic Hypertext Markup Language (DHTML) to add the new item to its current display of latest news.

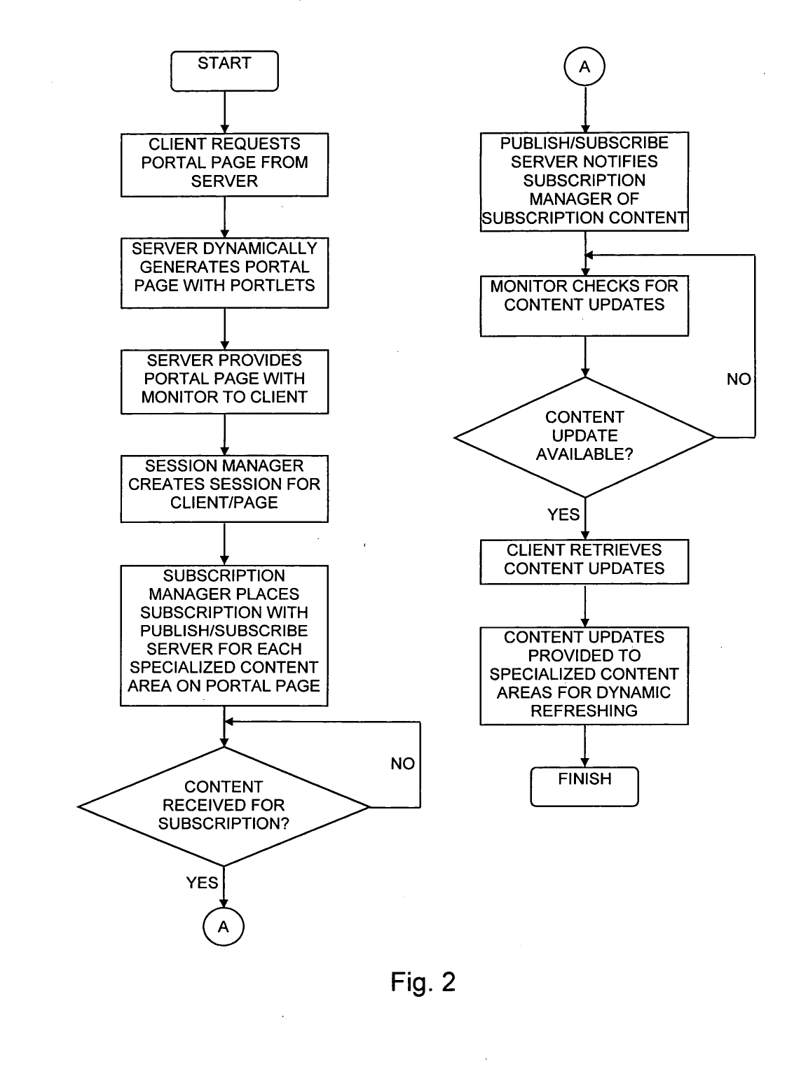

Reference is now made to FIG. 2, which is a simplified flowchart illustration of an exemplary method of operation of the subscription-based dynamic content update system of FIG. 1, operative in accordance with a preferred embodiment of the present invention. In the method of FIG. 2, which is described with respect to a web portal for illustration only, when a client requests a portal page, portal server 100 dynamically creates portal page 108, where specialized content areas 106 are generated using content provided by server-side portlets 104. Server 100 also generates subscriptions for content for specialized content areas 106 as required. Server 100 then provides portal page 108 together with monitor 122 to the client, and session manager 112 creates a session associated with the generated portal page and its set of subscriptions. For each specialized content area 106 that requires dynamic content updates, subscription manager 114 places a subscription for content updates with publish/subscribe server 118. Typically, the subscription remains active as long as session manager 112 determines that the related specialized content area 106 is active (e.g., displayed) at the client. Publish/subscribe server 118 matches published content received from content providers 120 with the subscriptions. When a match is identified, publish/subscribe server 118 notifies subscription manager 114, and the updated content is stored in event buffer 116. Monitor 122 periodically polls sub-system 110 for the existence of content updates and retrieves any content updates from event buffer 116. Alternatively, monitor 122 maintains a persistent connection with sub-system 110 through which monitor 122 receives content updates as they arrive from the publish/subscribe server. Monitor 122 provides content updates to the relevant specialized content areas 106, which may be client-side portlets capable of being called by monitor 122 to dynamically refresh its portion of the page, such as by using dynamic HTML.

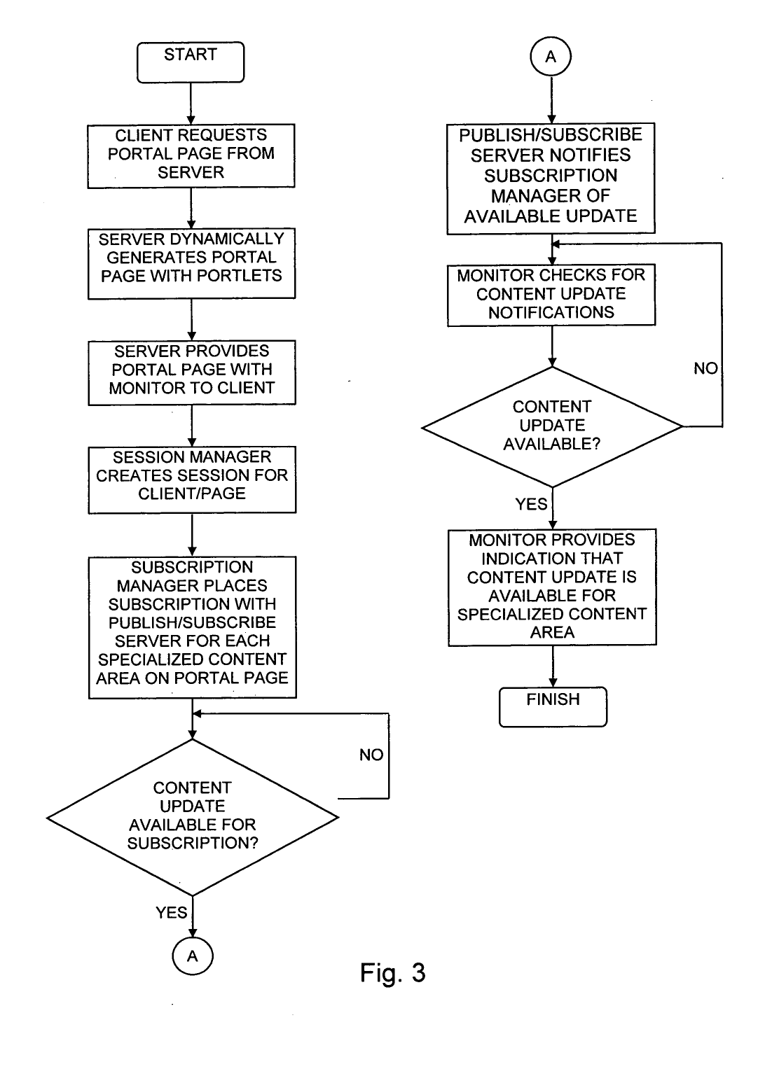

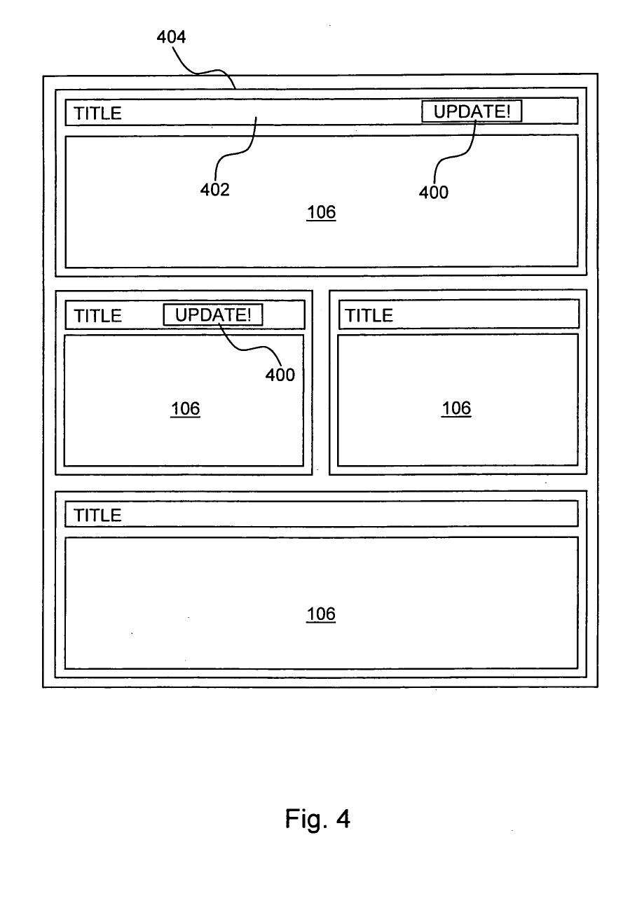

Reference is now made to FIG. 3, which is a simplified flowchart illustration of an exemplary method of operation of the subscription-based dynamic content update system of FIG. 1, operative in accordance with a preferred embodiment of the present invention, and additionally to FIG. 4, which is a simplified illustration of a portal page of the present invention. The method of FIG. 3 is substantially similar to the method of FIG. 2 with the notable exception that content providers 120 needn't publish content updates themselves, but need only provide a notification that updated content is available. Consequently, event buffer 116 need only store content update notifications that are received from publish/subscribe server 118 in connection with subscriptions. When monitor 122 determines from content update sub-system 110 that a content update is available for one or more of specialized content areas 106, monitor 122 does not retrieve the content update itself, but rather provides an indication that a content update is available. The indication may be a visual indication, such as an indicator 400 in FIG. 4 displayed within a title bar 402 of a window 404 which displays the specialized content area 106 for which the content update is available. Alternatively, the indication may be provided by changing the color of title bar 402 to indicate that a content update is available. To receive the updated content, the user may request that server 100 refresh the portal page, whereupon server 100 may retrieve the content for web page 108, including the updated content, using conventional techniques, and provide web page 108, now with the updated content, to client 101.

It is appreciated that one or more of the steps of any of the methods described herein may be omitted or carried out in a different order than that shown, without departing from the true spirit and scope of the invention.

While the methods and apparatus disclosed herein may or may not have been described with reference to specific computer hardware or software, it is appreciated that the methods and apparatus described herein may be readily implemented in computer hardware or software using conventional techniques. Thus, for example, client-side components described hereinabove may be implemented using the Extensible Markup Language (XML), Hypertext Markup Language (HTML), JavaScriptυ, Java Applets, ActiveXυ, or any combination thereof.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

1. A content update notification system comprising:
a content update sub-system comprising:
a session manager operative to associate a web page currently active at a client;
a subscription manager operative to create said subscription on a publish/subscribe server;
an event buffer operative to store a content update notification received from said publish/subscribe server in response to said content update notification being received from a content provider and in connection with said subscription; and
a monitor operative to receive said content update notification from said content update sub-system and provide an indication in association with said web page that a content update is available for said web page.

2. The system according to claim 1, further comprising a server operative to:
host a web site including at least one software component for dynamically generating at least one specialized content area of said web page, and
provide said web page for display on a client computer.

3. The system according to claim 2, wherein said server is a portal server and wherein said web site is a portal.

4. The system according to claim 2, wherein said software component is a portlet.

5. The system according to claim 1, wherein said monitor maintains a persistent connection with said content update sub-system through which said monitor receives said content update notification.

6. The system according to claim 1, wherein said monitor periodically polls said content update sub-system for the existence of said content update notification.

7. A method for providing a notification of updated content, the method comprising:
associating a web page currently active at a client with a subscription for content therefor;
receiving a content update notification from a content provider in connection with said subscription; and
providing an indication in association with said web page that a content update is available for said web page.

8. The method according to claim 7, further comprising:
creating said subscription on a publish/subscribe server; and
storing said content update received from said publish/subscribe server in response to a publication received from said content provider and in connection with said subscription.

9. The method according to claim 7, further comprising:
dynamically generating said web page including at least one specialized content area; and
providing said web page and said monitor to a client computer.

10. A computer program embodied on a computer-readable medium, the computer program comprising:
a first code segment operative to associate a web page currently active at a client;
a second code segment operative to receive a content update from a content provider in connection with said subscription; and
a third code segment operative to provide an indication in association with said web page that a content update is available for said web page.

11. The computer program according to claim 10, further comprising:
a fourth code segment operative to create said subscription on a publish/subscribe server; and
a fifth code segment operative to store said content update received from said publish/subscribe server in response to a publication received from said content provider and in connection with said subscription.
